(19) United States
(12) Patent Application Publication
(10) Pub. No.: US 2004/0150826 A1
(43) Pub. Date: Aug. 5, 2004

(54) Color measuring device

(76) Inventors: Seela Raj Rajaiah, (US); Bernard Chan Lye Hock, (US); Ong Mee Choo, (US); Ch?apos;ng Sheau Yang, (US); Frank Kiu Kwong Yew, (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/356,235

(22) Filed: Jan. 30, 2003

(51) Int. Cl. G01J 3/51

(52) U.S. Cl. 356/419; 356/406

(57) ABSTRACT

The present invention is an apparatus for measuring the color of a light signal. The apparatus includes a plurality of color sensing elements, an optical system for illuminating each of the color sensing elements with light from the light source, and a controller for determining the intensity and wavelength of the light signal from the signals generated by said color sensing elements. Each color sensing element generates an electrical signal that depends on the wavelength and intensity of light incident on the color sensing element. Each of the color sensing elements is characterized by a gain function that relates the electrical signal generated thereby to the wavelength and intensity of light incident thereon. Each of the gain functions is different from the others of the gain functions.

### FIELD OF THE INVENTION

The present invention relates to devices for measuring the color of a light source.

### BACKGROUND OF THE INVENTION

Devices for measuring the wavelength of a spectral line are known to the art. For example, an unknown light source can be applied to a device that deflects the light by an amount that depends on the wavelength of the light. The wavelength is then determined by measuring the position of the deflected light beam. Devices of this type based on prisms and diffraction gratings are well known in the art.

The cost of such devices limits their use. In addition, the devices tend to be bulky since the resolution of the device depends on spreading the light over a large range of spatial positions. Hence, a consumer level product for measuring colors is not available. For example, such a system would be useful in interior decorating applications to match colors.

### SUMMARY OF THE INVENTION

The present invention includes an apparatus for measuring the color of a light signal. The apparatus includes a plurality of color sensing elements, an optical system for illuminating each of the color sensing elements with light from the light source, and a data processing system for determining the intensity and wavelength of the light signal from the signals generated by said color sensing elements. Each color sensing element generates an electrical signal that depends on the wavelength and intensity of light incident on that color sensing element. Each of the color sensing elements is characterized by a gain function that relates the electrical signal generated thereby to the wavelength and intensity of light incident thereon. Each of the gain functions is different from the others of the gain functions. In the preferred embodiment of the invention, the apparatus measures the spectrum of light signals having wavelengths between a minimum and maximum wavelength. For each wavelength between the minimum and maximum wavelengths, the gain functions are chosen such that the signals from two of the color sensing elements are sufficient to determine the intensity and wavelength of a light signal having a single spectral line at that wavelength.

### BRIEF DESCRIPTION OF THE DRAWINGS

FIG. 1 is a block diagram of a color meter 10 according to one embodiment of the present invention.

FIG. 2 illustrates some exemplary gain functions.

FIG. 3 illustrates the ratio of two of the exemplary gain functions shown in FIG. 2.

### DETAILED DESCRIPTION OF THE PREFERRED EMBODIMENTS OF THE INVENTION

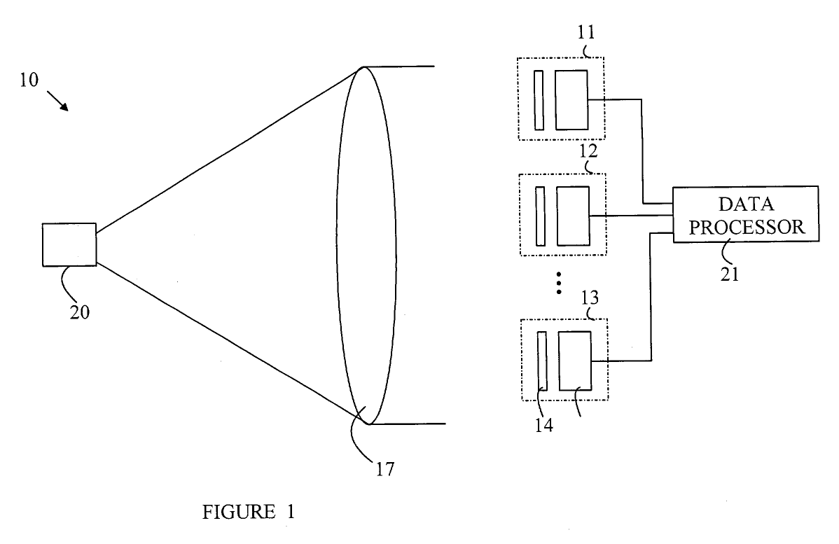

Refer now to FIG. 1, which is block diagram of a color meter 10 according to the present invention. Meter 10 includes a plurality of color-sensing elements. Exemplary elements are shown at 11-13 in this embodiment of the invention. However, as will be explained in more detail below, embodiments having different numbers of sensing elements can also be constructed. Each color-sensing element converts the light incident thereon to an electrical signal having a magnitude that depends on the intensity and wavelength of the light. In general, the response curves of the different sensing elements are different. That is, a light signal of intensity I and wavelength λ produces a different output signal from each of the detectors. The individual detectors can be constructed from conventional photodiodes 15 that are covered with different wavelength filters 14. Each wavelength filter transmits light in a band of wavelengths with a transmission coefficient that is a function of the wavelength. The response functions of each of the sensors can be ascertained by measuring the output signal as a function of wavelength and intensity using a calibration source whose wavelength and intensity can be varied in a known manner.

The present invention can be more easily understood by considering the simple case in which a light source 20 emits light of a single wavelength, λ₀, which is collimated by lens 17. For the purpose of this discussion, it will be assumed that each detector receives the same intensity of light from source 20. To simplify the following discussion, it will be assumed that the signal generated by the i^{th} detector when that detector is illuminated with a light signal of amplitude, A, and wavelength, λ, can be written in the form Sᵢ=AGᵢ(λ). That is, the sensor output is a linear function of the intensity of the incoming light signal. Detectors based on photodiodes having passive transmission filters typically have gain curves that obey this relationship over a large range of amplitudes. The gain function, Gᵢ(λ) can be measured for each sensor element using a calibrated light source having an intensity and wavelength that can be varied in a known manner. These gain functions are stored in data processor 21.

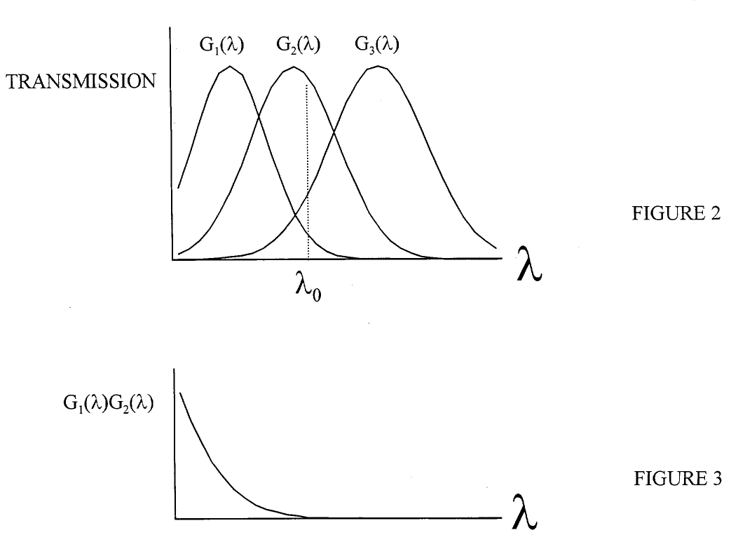

For the purposes of this example, it will be assumed that the gain functions associated with color-sensing elements 11-13 have the form shown in FIG. 2 at G₁(λ)-G₃(λ), respectively. Consider the output of the i^{th} detector when it is illuminated with a monochromic light signal of amplitude A₀ and wavelength λ₀. In general, there are a number of (intensity, wavelength) combinations that will produce the measured signal in any given sensor element. Hence, the output from a single detector is insufficient to determine the color and intensity of the signal. However, if the gain curves of several sensors are used, there will be a unique solution provided the gain curves of the various sensors are sufficiently different. In the simple case of a light signal consisting of a single spectral line, the ratio of the outputs of two detectors will provide a unique solution if the ratio of the gain functions is monotonic with respect to wavelength. In the current example, the ratio of the gain functions G₁(λ) and G₂(λ) is shown in FIG. 3. Since the ratio depends only on the wavelength of the spectral line, this curve uniquely defines the wavelength of the unknown line. The separate gain functions can then be used to determine the amplitude. If the ratio is not monotonic, the outputs from other detectors may be necessary to uniquely determine the wavelength of the light signal.

Now consider the case in which the unknown light source emits a spectrum consisting of N different spectral lines, and the detector includes M color sensing elements. The output of the i^{th} detector, for I=1 to M, is given by

$${S}_{i} = {\sum }_{j = 1}^{N} {A}_{j} {G}_{i} ( {λ}_{j} ) \qquad ( 1 )$$

Here, the j^{th} spectral line has an amplitude Aⱼ and a wavelength λⱼ. This system of equations can be solved for the amplitudes and wavelengths of the spectral lines provided there are enough detectors. In general, M must be greater than or equal to 2N. Since the above set of equations is non-linear in λⱼ, the system of equations must, in general, be solved using a data-fitting program. Since such programs are well known in the art, they will not be discussed in detail here.

It should be noted that including extra detectors allows one to test the assumption that the number of spectral lines is less than equal to a particular value. For example, consider the case in which the spectrum is assumed to be a single spectral line such as λ₀ shown in FIG. 2. If the value for λ₀ obtained using color sensing elements 11 and 12 differs substantially from the value for λ₀ obtained using sensing elements 12 and 13, then the assumption that the spectrum consisted of a single spectral line must have been incorrect, and a model using at least two spectral lines must be employed.

Various modifications to the present invention will become apparent to those skilled in the art from the foregoing description and accompanying drawings. Accordingly, the present invention is to be limited solely by the scope of the following claims.

What is claimed is:

1. An apparatus for measuring the color of a light signal, said apparatus comprising:
a plurality of color sensing elements, each color sensing element generating an electrical signal that depends on the wavelength and intensity of light incident on said color sensing element, each of said color sensing elements being characterized by a gain function relating said electrical signal to said wavelength and intensity of light incident thereon, each of said gain functions being different from the others of said gain functions;
an optical system for illuminating each of said color sensing elements with light from said light source; and
a data processor connected to each of said color sensing elements, said controller determining an intensity and wavelength for said light signal from said electrical signals.

2. The apparatus of claim 1 wherein each of said color sensors comprises a photodetector and an optical bandpass filter.

3. The apparatus of claim 1 wherein said wavelength is between a minimum and maximum wavelength and wherein, for each wavelength between said minimum and maximum wavelengths the signals from two of said color sensing elements are sufficient to determine the intensity and wavelength of a light signal having a single spectral line at that wavelength.
